(19) United States
(12) Patent Application Publication
(10) Pub. No.: US 2018/0168207 A1
(43) Pub. Date: Jun. 21, 2018

(54) APPARATUS AND METHOD FOR INTRODUCING A LIQUID INTO A SEALED FOOD PACKAGE

(71) Applicant: Steven Pippin, Farmington, MO (US)

(72) Inventor: Steven Pippin, Farmington, MO (US)

(21) Appl. No.: 15/843,329

(22) Filed: Dec. 15, 2017

Related U.S. Application Data
(60) Provisional application No. 62/435,549, filed on Dec. 16, 2016.

(51) Int. Cl. A23L 13/70; A47J 43/16

(52) U.S. Cl. CPC A23L 13/72; A23V 2002/00; A47J 43/16

(57) ABSTRACT

An ported marinade injection system useful for injecting flavoring fluids into vacuum-packaged meats. The apparatus may include a package couple, a port support couple, an injection port, a self-sealing port, and a port cover. The apparatus may be used by attaching the package couple and the port support couple to a package, attaching the self-sealing port and the injection port to the port support couple, injecting a marinade or other flavoring, and covering the port to seal the flavoring within the package.

### CROSS REFERENCE TO RELATED APPLICATION

The present application is related to and claims priority to U.S. Provisional Patent Application No. 62/435,549 filed Dec. 16, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of food or edible material: processes, compositions, and products and more specifically relates to internal application of nontransitory fluent material to solid edible by injecting, artificial pore formation or external pressure.

### 2. Description of Related Art

Closures are fastening devices used to seal a container. Closures may seal a container using mechanical means, adhesives, friction fits, or other methods. Different containers may require seals of different seal strengths; for example, some containers may need to be air-tight while others may only need to retain large solid components. However, many packages which are not designed to be reusable may lack closures of any sort. This may cause difficulties when the contents of a container need to be changed or added to. In particular, food products with disposable packaging may be impossible to access without transferring them to a reusable container. A suitable solution is desired.

U.S. Pub. No. 2010/0178398 to Victor Kingsun Wai, et al. relates to a marinating apparatus and process. The described marinating apparatus and process includes a marination device for marinating a food item. The marination device includes a flavor injector configured to inject during a first stage marinating process liquid preparation into the food. A vacuum canister configured to pressurize to a negative pressure state during a second stage marinating process the food. The food is vacuumed to remove the air in the food, and re-pressurized to an atmospheric state in the vacuum canister to imbue the liquid preparation into the food.

### BRIEF SUMMARY OF THE INVENTION

In view of the foregoing disadvantages inherent in the known food or edible material: processes, compositions, and products art, the present disclosure provides a novel apparatus and method for introducing a liquid into a sealed food package. The general purpose of the present disclosure, which will be described subsequently in greater detail, is to provide a ported marinade injection system useful for injecting flavoring fluids into vacuum-packaged meats. The device may include a package couple, a port support couple, an injection port, a self-sealing port, and a port cover. The device may be used by attaching the package couple and the port support couple to a package, attaching the self-sealing port and the injection port to the port support couple, injecting a marinade or other flavoring, and covering the port to seal the flavoring within the package.

An apparatus for introducing a liquid into a sealed food package via an injector needle is disclosed herein. The apparatus for introducing a liquid into a sealed food package via an injector needle includes an adhesive base, an injection port, and a self-sealing port. The adhesive base includes a package couple and a port support couple, the package couple configured to adhesively attach to the sealed food package. The injection port includes a package base interface and a seal retainer, the package base interface is configured to removably couple with the port support couple of the adhesive base. The self-sealing port is affixed to the seal retainer, and configured to permit insertion of the injector needle into the sealed food package while otherwise maintaining a seal of the sealed food package, the self-sealing port is further configured to maintain the seal upon removal of the injector needle.

A method of using an apparatus for introducing a liquid into a sealed food package via an injector needle is also disclosed herein. The method includes the first step of providing the apparatus described above, wherein the package couple includes an adhesive layer configured to adhesively attach to the sealed food package and at least one removable masking layer removably affixed to the adhesive layer and configured to maintain adhesive properties of the adhesive layer until removed, and also includes a port cover including a threaded interior portion configured to screw on to the threaded exterior portion of the seal retainer of the injection port such that said port cover is removably coupleable to said seal retainer, the port cover and having an open and a closed state, where the self-sealing port is accessible by the injector needle when the port cover is in the open state, and the self-sealing port is inaccessible by the injector needle when the port cover is in the closed state. The method including the further steps of removing the removable masking layer from the package couple and exposing the adhesive layer, adhering the package couple to the sealed food package via the adhesive layer; inserting the self-sealing port into the injection port, coupling the injection port with inserted self-sealing port to the port support couple, and screwing the port cover onto the injection port.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an apparatus for introducing a liquid into a sealed food package via an injector needle, constructed and operative according to the teachings of the present disclosure.

FIG. 1 is a perspective view of the apparatus for introducing a liquid into a sealed food package via an injector needle during an ‘in-use’ condition, according to an embodiment of the disclosure.

FIG. 2 is an exploded side view of the apparatus of FIG. 1, according to an embodiment of the present disclosure.

FIG. 3 is an exploded perspective view of the apparatus of FIG. 1, according to an embodiment of the present disclosure.

FIG. 4 is a side view of the apparatus of FIG. 1, according to an embodiment of the present disclosure.

FIG. 5 is a flow diagram illustrating a method of use for an apparatus for introducing a liquid into a sealed food package via an injector needle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a food or edible material: processes, compositions, and products and more particularly to an apparatus for introducing a liquid into a sealed food package via an injector needle, as used to improve the internal application of nontransitory fluent material to solid edible by injecting, artificial pore formation or external pressure.

Generally, the apparatus is a semi-reusable device that allows the consumer to inject flavoring directly into a cryovac or any vacuum-packed meats without having the liquid escape. Traditionally, when trying to inject meats the consumer has to prep it and put it in a bag, or open pan, which the injection flavoring will eventually come out of. This is a huge waste of the flavoring and doesn't give you the full flavor since it leaks out. The best option is the use a vacuum sealed bag, but if you puncture it then it's no longer vacuum sealed and you have the same issue. The apparatus for introducing a liquid into a sealed food package via an injector needle may provide an easy to use, semi-reusable device that provides for keeping flavoring inside the meat while it's still vacuum sealed. Generally, the apparatus may include a package couple ring that may be stuck on the packed meat. Next a port support couple may be attached to the package couple, such that a seal between the two parts is created. Likewise, a self-sealing port may be placed inside the injection port so that creates a seal. Further, the injection port may be snapped onto or otherwise coupled to the port support couple. In operation, a needle may be stuck through the self-sealing port and inject a marinade (or other liquid into the meat). The self-sealing port will reform when the needle is removed or otherwise keep a good seal. Embodiments may provide a screw on port cover, configured to further ensure sealing. In embodiments, the self-sealing port may be replaced or washed.

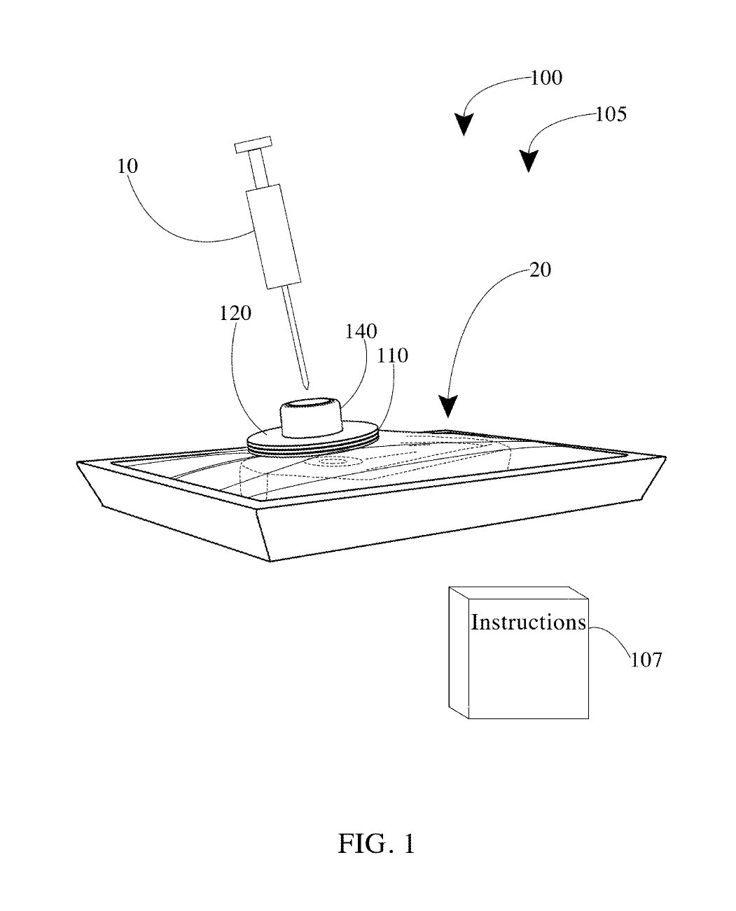

Referring now more specifically to the drawings by numerals of reference, there is shown in FIGS. 1-4, various views of an apparatus 100 for introducing a liquid into a sealed food package via an injector needle.

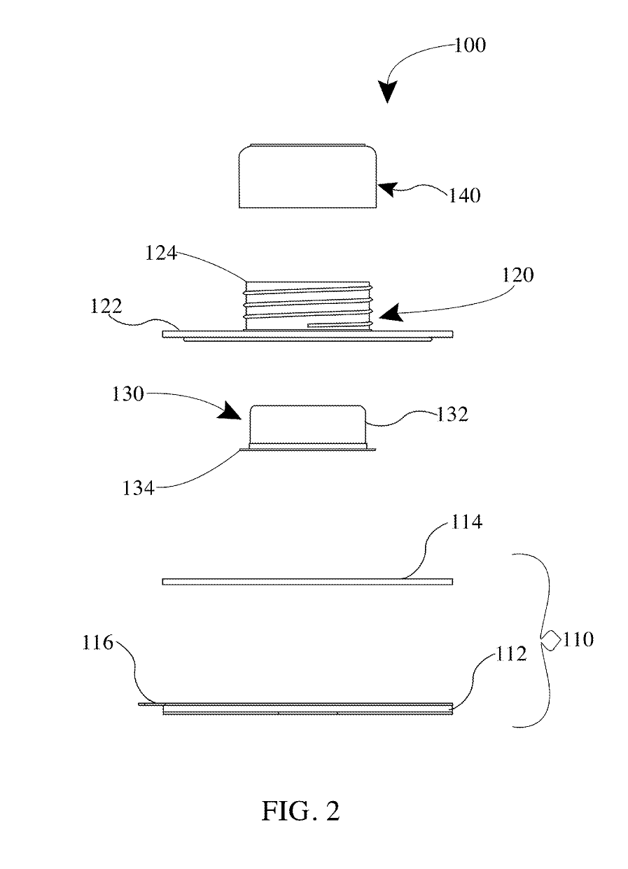

FIG. 1 shows the apparatus 100 for introducing a liquid into a sealed food package via an injector needle 10 during an ‘in-use’ condition 50, according to an embodiment of the present disclosure. The apparatus 100 may include an adhesive base 110 an injection port 120, and a self-sealing port 130 (FIG. 2). The apparatus 100 may further include a port cover 140.

According to one embodiment, the apparatus 100 may further include a set of instructions 107 and be arranged as a kit 105. The instructions 107 may detail functional relationships in relation to the structure of the apparatus 100 (such that the apparatus 100 can be used, maintained, or the like, in a preferred manner).

FIG. 2 is an exploded side view of the apparatus 100 of FIG. 1, according to an embodiment of the present disclosure. As above, the apparatus 100 may include the adhesive base 110, the injection port 120, and the self-sealing port 130, and alternately the port cover 140.

The adhesive base 110 may include a package couple 112 and a port support couple 114. The package couple 112 is configured to adhesively attach to the sealed food package 20 (FIG. 1). The package couple 112 includes an adhesive layer configured to adhesively attach to the sealed food package 20 and at least one removable masking layer 116 removably affixed to the adhesive layer and configured to maintain adhesive properties of the adhesive layer until removed.

The injection port 120 may include a package base interface 122 and a seal retainer 124, the package base interface 122 configured to removably couple to with the port support couple 114 of the adhesive base 110.

The apparatus 110 further includes a self-sealing port 130 affixed to the seal retainer 124, and configured to permit insertion of the injector needle into the sealed food package 20 while otherwise maintaining a seal of the sealed food package 20, the self-sealing port 130 further configured to maintain the seal upon removal of the injector needle. The self-sealing port 130 is configured to nest within the port support couple, is made of rubber, and is food-safe.

The port cover 140 is affixable to the injection port 120, and has an open and a closed state, where the self-sealing port 130 is accessible by the injector needle when the port cover 140 is in the open state, and the self-sealing port 130 is inaccessible by the injector needle when the port cover 140 is in the closed state. According to one embodiment, the port cover 140 may include a threaded interior portion, and the seal retainer 124 may include a threaded exterior portion. These components being configured to mate with each other respectively such that said port cover 140 is removably coupleable to said seal retainer 124.

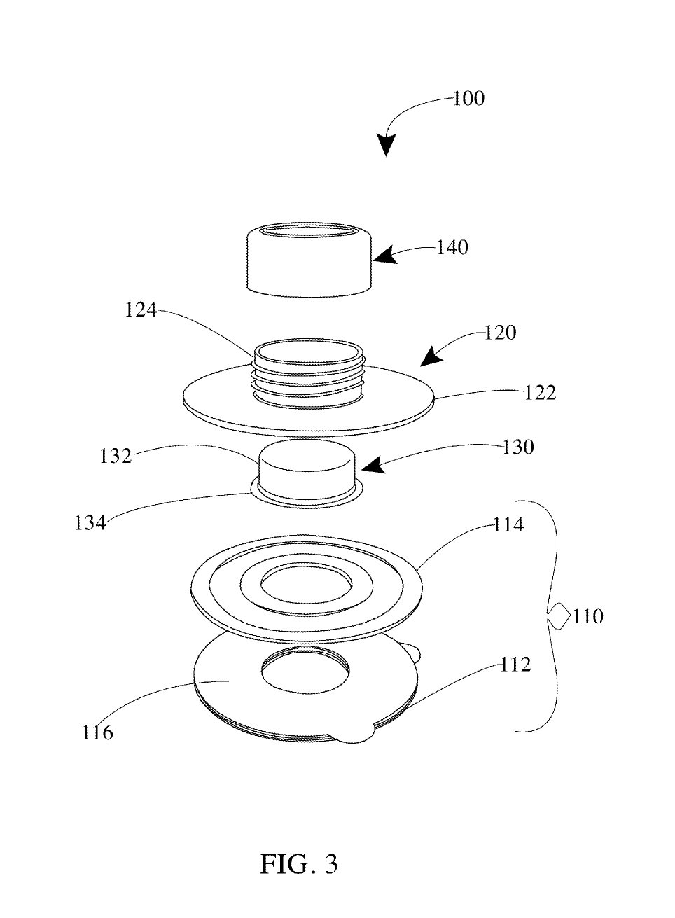

FIG. 3 is an exploded perspective view of the apparatus 100 for introducing a liquid into a sealed food package via an injector needle of FIG. 1, according to an embodiment of the present disclosure. As above, the apparatus 100 may include the adhesive base 110, the injection port 120, and the self-sealing port 130, and alternately the port cover 140. According to one embodiment, the package couple 112 may include double-sided tape. Further, the at least one removable masking layer 116 may include at least one protruding tab to assist with removal. The package couple 112 may be substantially planar and configured to contour to the sealed food package 20. The port support couple 114 may be configured to form a snap couple with the package couple 112 and releasably couple to said package couple 112 with said self-sealing port 130 contained there-between.

As shown, the apparatus 100 may include the self-sealing port 130 having a support wall and a deformable plug 132 positioned within the support wall, together configured to permit insertion of said injector needle, and further configured to maintain said seal upon removal of said injector needle. The self-sealing port 130 further includes a base gasket 134 fixed to and integrated with the deformable plug 132, the base gasket 134 configured to create a seal between the port support couple 114 and the package base interface 122 when the package base is interface 122 is coupled with the port support couple 114.

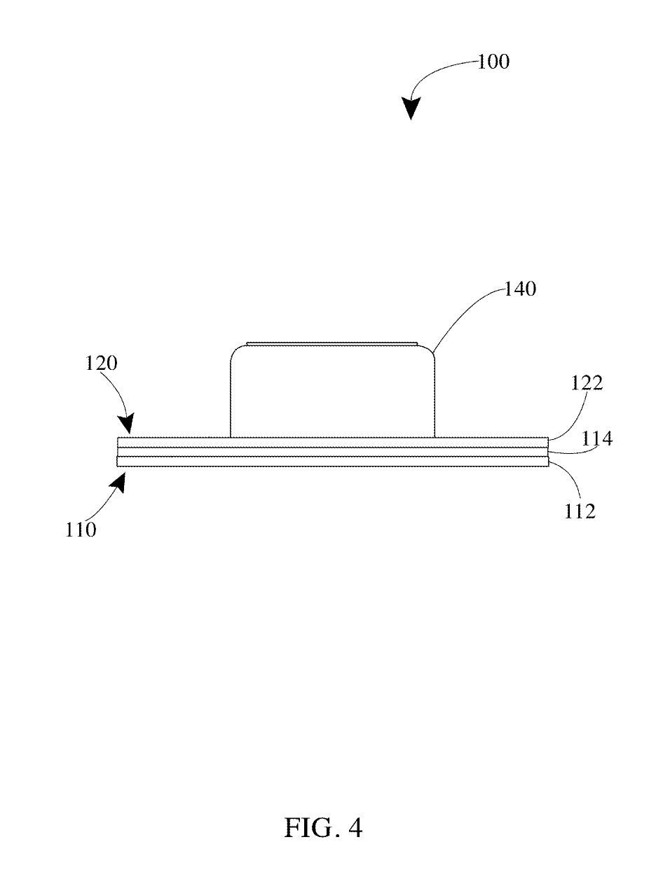

Referring now to FIG. 4, a side view of the apparatus 100 of FIG. 1, according to an embodiment of the present disclosure. As above, the apparatus 100 may include the adhesive base 110, the injection port 120, and the self-sealing port 130 (FIG. 3), and alternately the port cover 140. As shown, when assembled, the apparatus 100 may provide a compact sealed port or entryway that allows for a liquid such as a marinade or other food-safe solution can be introduced into the sealed food package 20 (FIG. 1) via the injector needle 10 (FIG. 1), after being stuck onto the sealed food package 20.

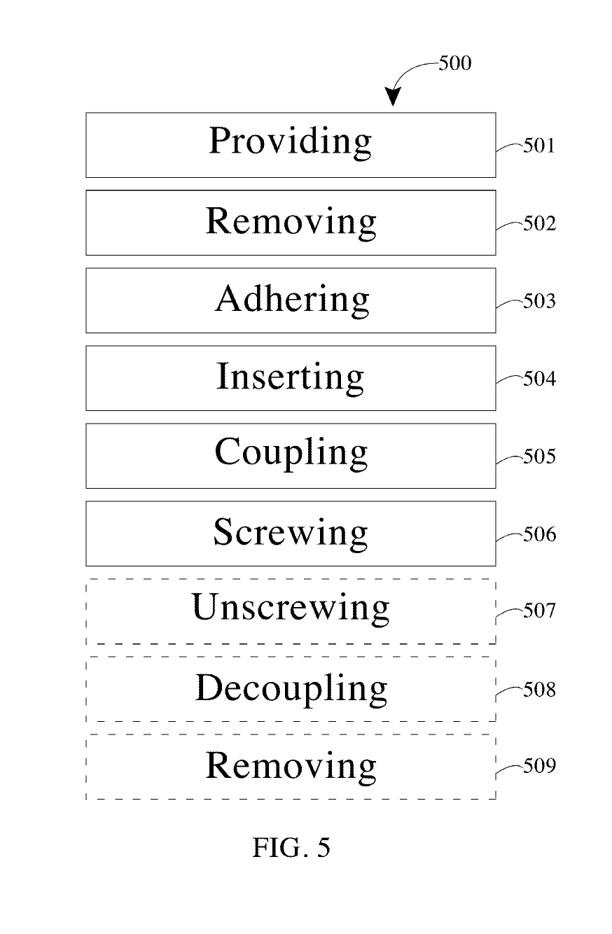

FIG. 5 is a flow diagram illustrating a method 500 for introducing a liquid into a sealed food package via an injector needle, according to an embodiment of the present disclosure. As illustrated, the a method 500 may include the steps of: providing 501 the apparatus 100, the apparatus including the adhesive base 110, the injection port 120, the self-sealing port 130, and the port cover 140 (as described above); removing 502 the removable masking layer 116 from the package couple 112 and exposing the adhesive layer; adhering 503 the package couple 112 to the sealed food package 20 via the adhesive layer; inserting 504 the self-sealing port 130 into the injection port 120; coupling 505 the injection port 120 with inserted self-sealing port 130 to the port support couple 114; and screwing 506 the port cover 140 onto the injection port 120. The method further may include the optional steps of: unscrewing 507 the port cover 140 from the injection port 120; decoupling 508 the injection port 120 from the port support couple 114; and removing 509 the self-sealing port 130 from the injection port 120.

It should be noted that the optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for an apparatus for introducing a liquid into a sealed food package via an injector needle 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for introducing a liquid into a sealed food package via an injector needle comprising:
an adhesive base including a package couple and a port support couple, the package couple configured to adhesively attach to the sealed food package;
an injection port including a package base interface and a seal retainer, the package base interface configured to removably couple to with the port support couple of the adhesive base; and
a self-sealing port affixed to the seal retainer, and configured to permit insertion of the injector needle into the sealed food package while otherwise maintaining a seal of said sealed food package, the self-sealing port further configured to maintain said seal upon removal of said injector needle.

2. The apparatus of claim 1, further comprising a port cover affixable to the injection port, and having an open and a closed state, where the self-sealing port is accessible by the injector needle when the port cover is in the open state, and the self-sealing port is inaccessible by the injector needle when the port cover is in the closed state.

3. The apparatus of claim 2, wherein the port cover includes a threaded interior portion.

4. The apparatus of claim 3, wherein the seal retainer includes a threaded exterior portion configured to mate with the port cover such that said port cover is removably couplable to said seal retainer.

5. The apparatus of claim 1, wherein the self-sealing port includes a support wall and a deformable plug positioned within the support wall, together configured to permit insertion of said injector needle, and further configured to maintain said seal upon removal of said injector needle.

6. The apparatus of claim 5, wherein the self-sealing port further includes a base gasket fixed to and integrated with the deformable plug, the base gasket configured to create a seal between the port support couple and the package base interface when the package base is interface is coupled with the port support couple.

7. The apparatus of claim 1, wherein the package couple includes an adhesive layer configured to adhesively attach to the sealed food package and at least one removable masking layer removably affixed to the adhesive layer and configured to maintain adhesive properties of the adhesive layer until removed.

8. The apparatus of claim 7, wherein the removable masking layer includes at least one protruding tab.

9. The apparatus of claim 1, wherein said self-sealing port is configured to nest within the port support couple.

10. The apparatus of claim 1, wherein said self-sealing port is made of rubber.

11. The apparatus of claim 1, wherein said self-sealing port is food-safe.

12. The apparatus of claim 1, wherein the liquid is a food marinade.

13. The apparatus of claim 1, wherein the liquid is a food-safe solution.

14. The apparatus of claim 1, wherein said package couple is substantially planar and configured to contour to said sealed food package when adhesively attached to the sealed food package.

15. The apparatus of claim 1, wherein said port support couple is configured to form a snap couple with the package couple.

16. The apparatus of claim 1, wherein said port support couple is configured to releasably couple to said package couple, said self-sealing port contained there-between.

17. An apparatus for introducing a liquid into a sealed food package via an injector needle, the apparatus comprising:
an adhesive base including a package couple and a port support couple, the package couple configured to adhesively attach to the sealed food package; and
an injection port including a package base interface and a seal retainer, the package base interface configured to removably couple to with the port support couple of the adhesive base; and
a self-sealing port affixed to the seal retainer, and configured to permit insertion of the injector needle into the sealed food package while otherwise maintaining a seal of said sealed food package, the self-sealing port further configured to maintain said seal upon removal of said injector needle; and
further comprising a port cover affixable to the injection port, and having an open and a closed state, where the self-sealing port is accessible by the injector needle when the port cover is in the open state and the self-sealing port is inaccessible by the injector needle when the port cover is in the closed state; and
wherein the self-sealing port includes a support wall and a deformable plug positioned within the support wall, together configured to permit insertion of said injector needle, and further configured to maintain said seal upon removal of said injector needle;
wherein the self-sealing port further includes a base gasket fixed to and integrated with the deformable plug, the base gasket configured to create a seal between the port support couple and the package base interface when the package base is interface is coupled with the port support couple;
wherein the package couple includes an adhesive layer configured to adhesively attach to the sealed food package and at least one removable masking layer removably affixed to the adhesive layer and configured to maintain adhesive properties of the adhesive layer until removed;
wherein the removable masking layer includes at least one protruding tab;
wherein said self-sealing port is configured to nest within the port support couple;
wherein said self-sealing port is made of rubber;
wherein said self-sealing port is food-safe;
wherein the liquid is a food marinade;
wherein the liquid is a food-safe solution;
wherein said package couple is substantially planar and configured to contour to said sealed food package when adhesively attached to the sealed food package.

18. The apparatus of claim 1, further comprising a set of instruction; and
wherein the apparatus is arranged as a kit.

19. A method for introducing a liquid into a sealed food package via an injector needle, the method comprising the steps of:
providing an apparatus for introducing the liquid into the sealed food package, the apparatus including:
an adhesive base including a package couple and a port support couple, the package couple configured to adhesively attach to the sealed food package, the package couple including an adhesive layer configured to adhesively attach to the sealed food package and at least one removable masking layer removably affixed to the adhesive layer and configured to maintain adhesive properties of the adhesive layer until removed
an injection port including a package base interface and a seal retainer, the package base interface configured to removably couple to with the port support couple of the adhesive base, the seal retainer including a threaded exterior portion;
a self-sealing port affixed to the seal retainer, and configured to permit insertion of the injector needle into the sealed food package while otherwise maintaining a seal of said sealed food package, the self-sealing port further configured to maintain said seal upon removal of said injector needle;
a port cover including a threaded interior portion configured to screw on to the threaded exterior portion of the seal retainer of the injection port such that said port cover is removably couplable to said seal retainer, the port cover and having an open and a closed state, where the self-sealing port is accessible by the injector needle when the port cover is in the open state, and the self-sealing port is inaccessible by the injector needle when the port cover is in the closed state;
removing the removable masking layer from said package couple and exposing the adhesive layer;
adhering the package couple to the sealed food package via the adhesive layer;
inserting the self-sealing port into said injection port;
coupling the injection port with inserted self-sealing port to the port support couple; and
screwing the port cover onto the injection port.

20. The method of claim 19, further comprising the steps of:
unscrewing the port cover from the injection port;
decoupling the injection port from the port support couple; and
removing the self-sealing port from the injection port.
